(19) United States
(12) Patent Application Publication
(10) Pub. No.: US 2010/0127187 A1
(43) Pub. Date: May 27, 2010

(54) Memory Unit for Producing Radiographic Images, and Method for Reading such a Memory Unit

(75) Inventor: Michael Thoms, Bietigheim-Bissingen (DE)

Correspondence Address: FACTOR & LAKE, LTD, 1327 W. WASHINGTON BLVD., SUITE 5G/H, CHICAGO, IL, 60607, US

(73) Assignee: DUERR DENTAL AG, Bietigheim-Bissingen (DE)

(21) Appl. No.: 12/301,938

(22) PCT Filed: May 16, 2007
(86) PCT No.: PCT/EP07/04355

§ 371 Date: Jul. 21, 2009

(30) Foreign Application Priority Data
May 24, 2006 (DE) 10 2006 024 861.9

(51) Int. Cl. G03G 5/10; G03B 42/00

(52) U.S. Cl. 250/473.1; 250/475.2

(57) ABSTRACT

An X-ray image memory unit includes a plurality of memory film pieces which can be moved between a recording configuration, in which they are situated one behind the other, and a scan configuration, in which they are individually accessible to reading light.

### CROSS-REFERENCE TO RELATED APPLICATIONS

This application claims the filing benefit of International Patent Application No. PCT/EP2007/004355, filed May 16, 2007, which claims the filing benefit of German Patent Application No. 10 2006 024 861.9 filed May 24, 2006, the contents of all of which are incorporated herein by reference.

### FIELD OF THE INVENTION

The invention concerns a memory unit for producing radiographic images of living or dead material; and further, to a method for reading such a memory unit.

### BACKGROUND OF THE INVENTION

Instead of classic silver films, for recording radiographic images using electromagnetic or corpuscular radiation, in particular X-ray images, memory films are increasingly used. Such memory films contain, distributed in a transparent plastic matrix, fine particles of luminous material (phosphor particles). The latter comprise a transparent crystalline base material (alkali or earth alkali halide), which is provided with suitable doping (usually rare earths) which forms colour centres. By absorbing radiation, these colour centres can reach a metastable excited state, from which they then relax by emitting fluorescent light if they are excited by a reading light (usually a red laser).

In practice, the layer thicknesses of such memory films are about 100 to 500 μm. The phosphor particles which are distributed in the plastic material scatter the reading laser light. It is therefore possible that memory centres which are not precisely on the axis of the reading light beam are deactivated. The scattering of phosphor particles therefore affects the resolution of the memory film.

If a higher resolution is important, the thickness of the memory film is chosen to be small, to keep the above-mentioned scattering effect small.

However, the reduction of the film thickness is associated with a reduction of the number of memory centres which interact with the radiation, e.g. the X-ray light. The improved resolution which is obtained by reducing the layer thickness is thus purchased by a reduction of the sensitivity of the memory film.

On the other hand, if the thickness of the memory film or the concentration of the memory centres in the memory film is chosen to be greater, improved sensitivity is obtained, but concessions have to be made regarding the resolution.

The present invention is directed to resolving these and other matters.

### SUMMARY OF THE INVENTION

An intention of this invention is to further develop a memory unit for producing radiographic images of living or dead material in such a way that the product of resolution and sensitivity is improved.

According to one embodiment of the present invention, this object may be achieved by a memory unit including memory film material, which contains memory centres of a memory luminous material, which can be brought by the radiation into a metastable excited state, from which they relax by emitting fluorescent light if they are irradiated by reading light, wherein the memory film material can be moved between a recording configuration, in which multiple memory film sections are one behind the other, and a scan configuration, in which the memory film sections are each individually accessible for the reading light.

In the case of the memory unit according to the invention, there are multiple memory film sections, which can be moved between a recording configuration and a scan configuration. In the recording configuration, the memory film sections, as seen in the direction of the X-ray light, are one behind the other, and behave like one memory film of corresponding thickness. On the other hand, to read the latent image, the memory film sections are brought into the scan configuration, in which only one memory film section at a time faces the reading light beam.

The memory unit according to the invention thus behaves during recording like a thick memory film, whereas during reading it has the properties of a thin memory film. The individually scanned images of the single memory film sections are then combined electronically into a total image, which has high resolution and reproduces even low-intensity image areas well. The total image which is obtained in this way is also characterized by a significantly improved signal-to-noise ratio.

Also, with the memory unit according to the invention, partial images which are exposed at different strengths are obtained automatically, since the full quantity of X-ray light acts only on the front memory film section, whereas for the rear memory film sections, the memory film sections in front of them act as reducers.

Typically, the X-ray absorption of usual, even film materials is between 20% and 50%. With 20% absorption, the incident X-ray light intensity for a fourth memory film section is already reduced to half.

With 50% absorption, the quantity of X-ray light which falls on a fourth memory film section is only 12.5%.

Thus, using the memory unit according to the invention, not only can images with a significantly improved signal-to-noise ratio be obtained, but also, with one and the same recording, images as they would be obtained with different X-ray doses, and this with only a single exposure of a patient or workpiece.

The memory unit according to the invention is characterized by very simple construction, and can be put together, even with different overall characteristics, from simple standard elements.

A further development of the present invention includes a holding device, which in the recording configuration holds single memory film pieces together—and in full alignment or partly overlapping alignment, is advantageous with respect to simple one-piece ease of handling of the memory unit. Additionally, the different memory film sections have a precisely prescribed relative position, which simplifies the evaluation of the single images which are obtained with them.

If the film sections only partly overlap, i.e. if parts of the film sections project at the sides, by using a prescribed film section, a memory unit which has a greater area than one film section can be produced.

In another aspect of the present invention, the case of a memory unit includes the holding device in the form of a lightproof cassette, wherein the holding device can also act as a light-proof cassette, and thus fulfils two functions.

In a further development of the present invention the lightproof cassette includes at least one movable wall and is advantageous with respect to simple insertion and removal of the memory film sections into the cassette.

In yet another further aspect of the present invention, the movable wall is in the form of a housing part, a lid, a bolt, or a pivotable flap and provides a temporary access to the inside of the cassette.

Another further development of the present invention includes the cassette having two movable walls opposite each other, wherein the memory film sections in the cassette can also easily be removed from the cassette, namely by pushing them out by means of a suitable pushing tool, which can grip on the edges of the memory film sections.

A further aspect of the present invention includes at least a front cassette wall, and preferably also a rear one, has plane-parallel main limiting surfaces such the cassette walls in the propagation direction of the radiation have no uneven effect on the X-ray images.

A further development of the present invention includes the holding device being made of material which is transparent to X-ray light, which also acts to keeps the effects of the holding device on the obtained radiographic image small, or to remove them completely.

As explained above, the other memory film sections in front of a memory film section under consideration also represent reducers for the memory film section under consideration. If, for a special application, even stronger reduction of the radiation from a memory film section to a memory film section behind it is desired, an additional absorber layer, which is only partly transparent to the radiation, can be provided between these two memory film sections. Such an additional absorber layer has the advantage that it also reduces the radiation background which the object generates by scattering.

If desired, such an additional absorber layer can also be given different thickness in different areas, e.g. in a wedge shape. In this way, in image areas where strong over-exposure must be assumed, the dose can be deliberately reduced again.

Such an additional radiation absorber layer will usually consist of metallic material. Metallic materials have typical X-ray light absorption edges, depending on their atomic number. If the X-ray light in use is broadband, part of the X-ray light which has a greater energy than a predetermined energy can be reduced or removed completely using a metallic X-ray light absorber layer, or single images which are recorded with X-ray beams of different energy can be obtained.

In another aspect of the present invention, multiple different absorber layers can also be used, to capture multiple energy ranges of the radiation separately. That is, the memory film section stack includes at least two absorber layers which are partly transparent to the radiation, and which have different absorption curves.

In a further development of the present invention, a strong final radiation absorber layer is provided on the back of the stack of memory film sections and is advantageous with respect to the lowest possible radiation load on a patient.

A further advantageous development of the present invention pertains to the simple ease of handling of the memory unit, wherein the final absorber layer remains permanently joined to the holding device (e.g. cassette).

A still further advantageous development of the present invention provides for the determination of the exact aligning position of two single images by computing correlation functions of the images themselves while rotating and shifting single images relative to each other. For low-contrast radiographic images, it is possible to improve the alignment of the single images by exposing, on the single images, reference marks which show clear contrasts, and on the basis of which the images can be aligned easily and with high precision.

In yet a further aspect of the present invention, the reference marking means are permanently carried by the holding device, thus providing an advantageous effect with respect to simple ease of handling.

For many purposes, it will be advantageous if the single memory film sections are single memory films, which are only stacked one behind the other for recording an X-ray image. The single memory films can then be read using automatic scanners such as are used for traditional one-layer memory films.

However, for some applications it is also advantageous if the memory film sections are joined captively. They can then be handled in one piece even in the scan configuration, and in particular they can be inserted together into a scanner with a handle. The overall characteristics of the memory film stack are then necessarily always the same, and do not have to be specially documented.

A still further development of the present invention is advantageous in that the different memory film sections have a permanently predetermined relative position. Thus at the most small computations are necessary to align the different electronic partial images with each other.

Another aspect of the present invention provides for the ability to align the memory film sections at least coarsely when they are removed from the holding device, and to move them together.

The further development of the invention also makes it possible to join a relatively large number of memory film sections, without the joining means which belong to different pairs of memory film sections obstructing each other.

Another further development of present invention includes at least some of the memory film sections being rotatably joined to each other by a bearing shaft, which is also advantageous with respect to rapid, simple electronic alignment of the different partial images, since only one degree of freedom has to be taken into account.

In still further developments of the present invention it is possible to implement, in various ways, memory film sections which have different sensitivity and/or different resolution. In this way, with a single recording, different single images can be obtained, and in strongly exposed image areas high resolution can be achieved, whereas in weakly exposed image areas there is high sensitivity.

According to another aspect of the present invention, the resolution of a memory unit can be adjusted via the optical properties of the matrix, while the structure of the memory film material (type and proportion by weight of the phosphor particles, type and thickness of the matrix) is otherwise unchanged, by adding to the matrix a component (e.g. a blue dye for a red laser beam) which absorbs the laser beam which is used for reading. The laser beam thus does not reach, or reaches less, the further back regions of the memory film material, and is therefore less scattered, meaning improved resolution.

A further aspect of the present invention is directed to a method of reading a memory unit.

This method is characterized in that the different memory film sections are read separately in the scan configuration, and the single images which are obtained in this way are combined into a total image.

Such a combination may include simply adding the single image pixel signals by amplitude. However, the combination of the images can also be weighted, by replacing over-exposed (and if appropriate also under-exposed) image areas, in which either the memory film material or the scanner no longer works linearly, with image areas of the memory film sections with the next weaker (or in the case of under-exposure, next stronger) exposure, in which the brightness ratios are still such that linear working of the memory film material and the scanner was ensured.

This image part is then scaled by a factor, and put in place of the over-exposed (or under-exposed) image part, the scaling factor being determined on the basis of image areas of the two single images under consideration, in which, for both single images, linearity of memory film material and scanner can be assumed.

In a further aspect of the present invention, the single images are aligned before being combined, by a correlation method and/or using exposed marks with rotation and/or shifting and/or by changing the imaging scale. Such an aspect is advantageous with respect to automatic alignment of the different single images. And such a method makes it possible to use, in particular, memory film sections which are mechanically completely separated from each other, and which, among other things, can be of interest because the memory film section stack for different recordings can be put together freely as required out of memory film sections of different characteristics, and absorber films can optionally be placed between the single memory film sections, if wanted.

In a still further development of the present invention, the single image pixel signals are added to the total image pixel signals using weighting factors, which makes it possible to combine single images of very different intensity in one total image, with correct intensity.

In yet a still further development of the present invention, the weighting factors can advantageously be obtained from the different single images.

For some applications, it is advantageous to represent the intensity conditions as diminished or amplified, which can be attained by subjecting the total image pixel signals to an amplitude transformation according to a specified characteristic curve, e.g. a logarithmic characteristic curve, or according to a root function.

A still further aspect of the present invention ensures a considerable improvement of the signal-to-noise ratio whereby single image pixel signals are combined into the total image pixel signals by adding their amplitudes, weighted as required.

In yet another still further aspect of the present invention, the single image pixel signals are combined into the total image pixel signals while selecting a subset of the single image pixel signals which are within a specified amplitude window, and that the selected single image pixel signals are weighted according to the proportion of X-ray light which the associated memory film section absorbs—thereby providing a total recording with true intensity over a very large intensity range to be obtained.

It is to be understood that the aspects and objects of the present invention described above may be combinable and that other advantages and aspects of the present invention will become apparent upon reading the following description of the drawings and detailed description of the present invention.

### BRIEF DESCRIPTION OF THE DRAWINGS

FIG. 1 shows a cross-section through a memory unit for producing X-ray images, said unit including multiple memory film pieces stacked one behind the other;

FIG. 2 shows a schematic representation of the latent partial images which are obtained in the memory film pieces of the memory unit according to FIG. 1 by recording a molar tooth with its immediate environment;

FIG. 3 shows a block diagram of a device for reading the memory unit according to FIG. 1, and for creating a total image from the single images of the different memory films;

FIG. 4 shows a similar view to FIG. 1, but with a modified memory unit;

FIG. 5 shows a plan view of a memory film arrangement in a one-layer scan configuration, from which a memory film arrangement with four successive memory film sections behind each other can be produced by folding;

FIG. 6 shows a side view of a modified memory film arrangement, in a one-layer scan configuration;

FIG. 7 shows a plan view of the front of the memory film arrangement according to FIG. 6;

FIG. 8 shows a side view of a modified memory film arrangement, which is formed by joining separate memory film pieces by flexible pieces of material, which form hinges;

FIG. 9 shows a plan view of a further memory film arrangement, in which different memory film pieces are arranged one behind the other on a bearing shaft;

FIG. 10 shows a cross-section through a further modified memory unit, with two memory film sections joined by flexible pulling means;

FIG. 11 shows a view of the memory unit according to FIG. 10, after a rear memory film piece is first pulled out of the cassette;

FIG. 12 shows a plan view of the two flexibly joined memory film pieces, seen perpendicularly to the main surface; and,

FIG. 13 shows a view of a memory unit, which has memory film sections lying one above the other like scales.

### DETAILED DESCRIPTION OF THE DRAWINGS

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

Above and in the claims, in general radiographic images which are obtained using corpuscular beams or electromagnetic radiation are mentioned. Among the corpuscular beams there are, in particular, neutrons, electrons, protons and helium nuclei, whereas among the electromagnetic radiation there is primarily X-ray radiation, but also UV light, or if suitable phosphor particles are used, also light of longer wavelengths.

The following explanation of embodiments refers non-restrictively to X-ray images.

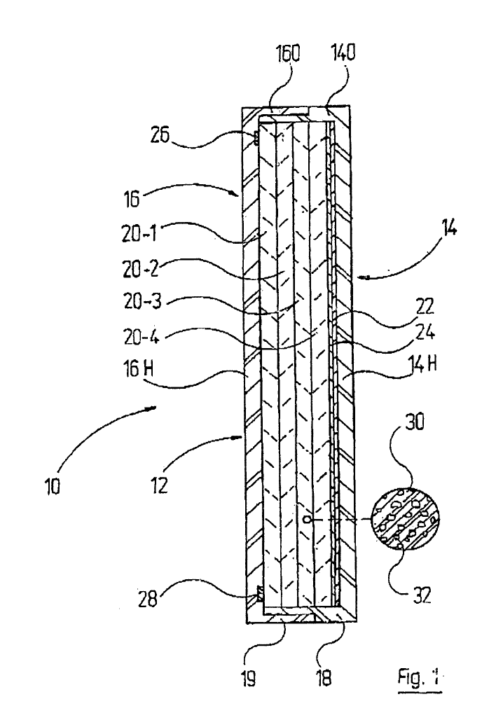

In FIG. 1, a memory unit as a whole is designated by 10. It is used for recording X-ray images which are characterized equally by high sensitivity and good resolution.

The memory unit 10 includes a cassette which is designated as a whole by 12, is of box-like form, and has a cassette lower part 14 and a cassette upper part 16. These are joined to each other in a lightproof, separable manner by overlapping, surrounding walls 18, 20.

The cassette lower part 14 and cassette upper part 16 each have an extended main wall, 14H and 16H respectively, which has plate-like, plane-parallel main limiting surfaces, which carry on their edges a surrounding wall 14U and 16U respectively.

Within the cassette 12, there are four independent memory film pieces 20-1, 20-2, 20-3 and 20-4.

For the purposes of the description, let it be assumed that the left-hand side of the cassette 12 in FIG. 1, under recording conditions, faces an X-ray source and the object (patient or workpiece) which is in front of it and irradiated by it.

On the floor of the cassette lower part 16, an absorber layer 24 made of a metal with a high atomic number, usually lead, is attached by an adhesive layer 22. The absorber layer 24 is so thick that behind the memory unit 10, an appreciable X-ray intensity is no longer observed.

On the inside of the cassette upper part 16, close to the edge, two marker discs 26, 28 are embedded. These also consist of a material with high X-ray light absorption, such as lead, and throw a shadow on all the memory film pieces 20 behind them.

The memory film pieces 20 each include a transparent, clear plastic matrix 30, in which fine phosphor particles 32 are embedded.

In practice, the memory film pieces 20 can also include a supporting layer which ensures the necessary mechanical strength, but which is not interesting in detail here, because in general it is intended to behave neutrally both when the latent image is exposed and when it is read.

The phosphor particles 32 consist of a transparent matrix which is transparent to X-ray light and visible light, and which is usually an alkali or earth alkali halide material. Foreign metal atoms, which result in the formation of colour centres, are built into this salt material as doping. Typical doping atoms are the rare earths. At the doping points, there are electronic local states, which are brought by absorption of an X-ray quantum into an excited electronic state which is metastable. Typical lifetimes of such states are between a few minutes and 30 minutes.

The strength of the absorption of the X-ray light, and thus the sensitivity of the memory plate, can be influenced by the material through the atomic number of the ions, in particular the anions, of the salt.

The excited state of the memory centres can be brought back to the ground state by irradiation in the excited state with a reading light (typically a fine red laser beam), by which means a more excited state, from which an optical transition into the ground state is permitted, is reached.

The fluorescent light signal which is measured with a light detector at a known position of the reading light beam gives the electrical pixel signal which is assigned to the position.

If the memory unit 10 shown in FIG. 1 is used to irradiate an object, e.g. a jaw area, the result in the memory film pieces 20-1 to 20-4 is similar latent images of the object. The four latent images are not exactly alike even if the memory film pieces 20-1 to 20-4 are cut from the same initial material. This is because for a memory film piece under consideration, the other memory film pieces to the left in FIG. 1 also represent absorber layers. The latent images which are generated in the single memory film pieces 20 thus differ with respect to the intensity of the latent images, or “blackening”.

If the latent images of the memory film pieces 20-1 to 20-4 are read separately in a scanner, the single images each have a good resolution, corresponding to the thickness of the memory film piece. Then, by overlaying the obtained single images electronically, a total image of the object is obtained, corresponding to the intensity conditions which would have been obtained with a single memory film piece, the total thickness of which corresponds to the sum of the thicknesses of the memory film pieces 20. However, such an X-ray image would have a much worse resolution, since the laser beam which is used to read the latent image is more strongly scattered in the thick single layer, and even excited memory centres which are at a significant distance from the laser beam axis, and actually should not be scanned at all, are emptied by the scattered reading laser beam.

To make correct electronic combination of the single images which are obtained by the memory film pieces 20-1 to 20-4 easier, the marker discs 26, 28, which are in the outer image area and throw shadows at exactly the same places onto the memory film pieces 20-1 to 20-4, which are arranged one behind the other, are provided. On the basis of these shadows, which can be seen with good contrast even in the electronically developed single image, the different single images can then be aligned by rotating and shifting, by computing locally the overlap of the shadows of the marker discs 26, 28, e.g. by creating a correlation function, and choosing correction movements of the images (rotating and shifting) so that the overlap becomes a maximum.

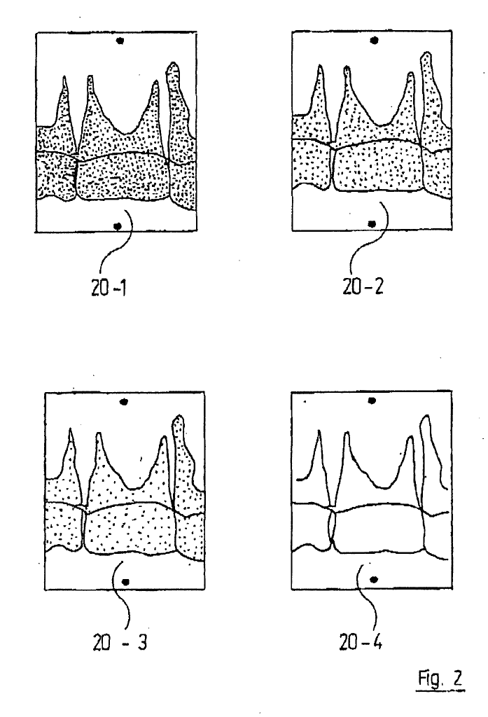

As explained above, the single images which are obtained by the memory film pieces 20-1 to 20-4 differ in their intensity, as shown in FIG. 2.

If the intensities are standardised to the incident intensity on the memory film piece 20-1, identical memory film pieces are used, and the absorption is 20%, the proportion of X-ray light which still reaches the fourth memory film piece 20-4 is 51%. On the other hand, if each memory film piece absorbs 50%, only 12.5% of the light reaches the fourth memory film piece 20-4.

From the above numbers, it can be seen that with low absorption, it can be very beneficial, with respect to a further improvement of the sensitivity of the memory unit, to put more than four memory film pieces one behind the other.

With the construction of the memory unit proposed here, the number of memory film pieces placed one behind the other has no effect on the resolution of the image. In all cases, this is the same as what is obtained for a one-layer piece of film material. Only reasons of space, which could be an argument against in the case of intra-oral recordings, financial reasons, and a longer reading time can be arguments against using a large number of memory film pieces one behind the other.

In the case of the cassette 12 according to FIG. 1, the exposed memory film pieces 20 are removed, and deleted memory film pieces which are ready for a new recording are inserted, after the cassette upper part 16 is removed from the cassette lower part 14.

As a modification, instead of a removable housing part, a bolt, a lid or a pivotable cassette part can be provided.

In the case of the cassette 12 according to FIG. 1, one side of the cassette can be opened. In a modification, it can also be provided that two opposite housing sides can be opened. It is then unnecessary to exert any tensile forces on the memory film pieces, which always causes the risk of damage to the sensitive main surfaces of the film, and instead the memory film pieces can be pushed on their narrow sides by a suitable tool.

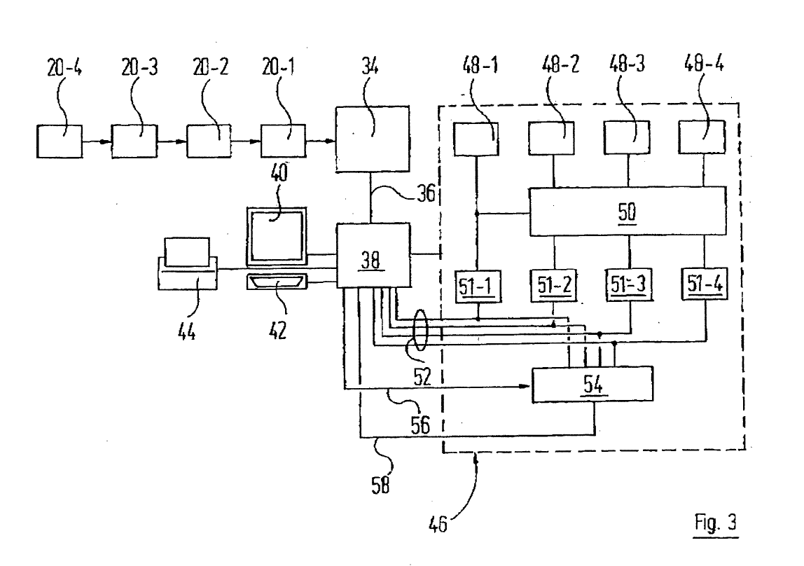

FIG. 3 shows schematically a device for reading the memory unit 10, i.e. the memory film pieces 20-1 to 20-4 in the cassette 12. These are shown in the top left part of FIG. 3.

After being removed from the cassette 12, the memory film pieces 20-1 to 20-4 are fed one after the other to a scanner 34, which moves the memory film pieces 20 one after the other over a reading gap, which is scanned continuously by a thin laser beam. An example of such a scanner is described in DE 199 42 211 A1, to which reference may be made regarding it.

For each of the latent images which the memory film pieces 20-i carry, the scanner 34 generates an electrical image in the form of electrical pixel signals. These are passed via a line 36 to a computer 38, which is connected to a monitor 40 and a keyboard 42, to control work, e.g. to output results. The computer is also connected to a printer 44.

For purposes of explanation, an image processing unit 46 is shown as an external unit which is connected to the computer. However, in practice this can also be a program which runs in the computer 38, if necessary in association with special hardware, which is arranged on a computer card.

Broadly speaking, the image processing unit 46, which is shown as an external unit for purposes of explanation, has the task of putting together, from the single images which are obtained from the memory film pieces 20-1 to 20-4, a total image, which has a higher dynamic range and a better signal-to-noise ratio than the single images can have, because the memory film material has only a limited dynamic range, and the scanner 34 also works linearly only within a specified intensity range.

It also generates, in the way described in more detail below, a total image which has a better resolution than a total image of a correspondingly thicker film piece can have.

In the image processing unit 46, the reference numbers 48-1 to 48-4 designate memories, in which the single images which the memory film pieces 20-1 to 20-4 supply are stored.

The output signals of the memories 48-1 to 48-4 are applied to an alignment computer 50. The memory 48-1 is used as a reference image generator, i.e. the alignment computer 50 rotates and shifts the images in the memories 48-1 to 48-4 so that they align exactly with the shadows of the marker discs 26, 28 on them.

The thus aligned images are held in further memories 51-2 to 51-4, whereas the reference image contained in the memory 48-1 is passed directly to a memory 51-1.

The output signals of the memories 50-1 to 50-4 are fed back via a cable 52 to the computer 38.

The memories 51-1 to 51-4 are also connected to inputs of an image overlaying computer 54. This puts under use of control signals, which the computer 38 transmits to it via a line 56. The total image is returned to the computer 38 via a line 58.

In the simplest case, the total image can be obtained simply by overlaying the images in the memories 51-1 to 51-4 additively, pixel by pixel. An image with a significantly improved signal-to-noise ratio is then obtained.

Another kind of combination can be that the total image is optimised so that over a very large intensity range, the intensity of the X-ray image is correctly reproduced.

To do this, firstly, for all image areas in the memories 51-1 to 51-4, those for which it is guaranteed, on the basis of the properties of the memory film pieces and scanner, that the pixel signals are proportional to the X-ray light, would be selected. These image areas are then computed additively together using backward weighting (taking account of the light which is absorbed in front of the memory film piece under consideration).

Those image areas of a memory 51-i for which linear ratios can no longer be assumed are rejected. They are replaced by the corresponding image areas of the other memories, which are multiplied by a scaling factor, which was determined by comparing image parts in which, for both images to be compared, linear ratios can be assumed.

In detail:

If over-exposure (overloading) is present in areas of an image, the corresponding pixels are rejected, and the intensity of the rejected pixels is extrapolated from subordinate pixels which are not overdriven. Preferably, this is done by extrapolating the total information of the pixels which are not over-exposed.

The over-exposed areas will usually be found in the first memory film piece 20-1. Here it is assumed that the memory film pieces 20 all have the same ability to absorb X-rays. The ratios would be different only if the first memory film piece, because of the type or concentration of memory centres, or because of less thickness, had lower absorption than a subsequent memory film piece. However, logically the same ratios apply. It would then only be necessary formally to change the numbering of the memory film pieces (differing from the situation in the stack).

Let it be assumed that, apart from statistical fluctuations, the intensities Iᵢ of the successive single images can be represented as predetermined fractions xᵢ of the intensity of the first image I₁:Iᵢ=xᵢI₁.

The intensity of a pixel of the over-exposed area is then set to I_{ges}=ΣgᵢIᵢ/xᵢ (i=1, 2, 3, . . . ), where gᵢ=IᵢΣIⱼ (j=1, 2, 3, . . . ).

Choosing the weighting factors gᵢ in this way ensures that the signal-to-noise ratio of the obtained image I_{ges} is good.

The procedure for under-exposed areas, which can be created by suitable reduction of more strongly exposed single images, can be similar.

In this way, an image which has true intensity over a very large intensity range is obtained.

If the dynamic range of this image is so great that the dynamic range cannot even be reproduced on the screen or printer, the total image can still be converted according to a specified characteristic curve, in particular a logarithmic characteristic curve or a root function, in particular a square root function. An image which is no longer proportional to the X-ray light in its blackening levels is then obtained; however, an experienced viewer, in the course of time, can interpret even such an image correctly, in particular as far as detecting contours is concerned.

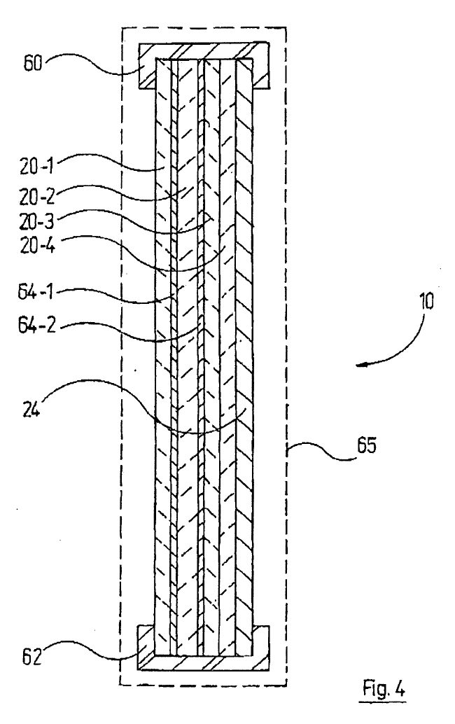

FIG. 4 shows a modified memory unit 10, with four memory film pieces 20-1 to 20-4, which are held on two opposite edges by U-profile rails 60, 62.

Between the memory film pieces 20-1 and 20-2, and between 20-2 and 20-3, absorber films 64-1, 64-2, each of which is partly transparent to X-ray light, are arranged. These absorber films can have, for instance, a transparency of 80%, to achieve, together with an 80% transparent memory film piece, a weakening of the X-ray light to 64%.

Thus only about 40% of the incident X-ray light falls onto the memory film piece 20-3. If both the memory film piece 20-3 and the absorber film 64-2 also have 80% transparency, about 26% of the X-ray radiation still reaches the memory film piece 20-4.

It can be seen that through the transparency of the absorber films, the number of them and their arrangement in the memory film piece stack, it is possible to control how the intensity ratios of the single images recorded by the memory film pieces 20-1 to 20-4 are.

In the case of the memory unit shown in FIG. 4, the absorber layer 24 is a stronger, self-supporting layer, if appropriate a composite layer of a layer of lead and a substrate which essentially resists bending.

In the memory unit 10 of FIG. 4, single, independent memory film pieces 20 are also used, so that the same advantages are obtained as were described above with reference to the embodiment of FIG. 1.

Here too, memory film pieces which contain different memory centres, which interact differently with the X-ray light, can be used. For instance, the crystalline base material of the memory phosphor can be adapted to the chemical nature of an X-ray contrast means. For instance, if an X-ray is recorded with BaSO₄ as the contrast means, BaFBr:Eu can be used as the memory luminous material in object-side memory film pieces, and SrFBr:Eu can be used as the memory luminous material in rear memory film pieces.

The object-side memory film pieces and the memory film pieces away from the object then record the X-ray spectrum at different wavelengths.

A similar effect can be achieved by using different absorber films 64, which have absorption edges at different energies.

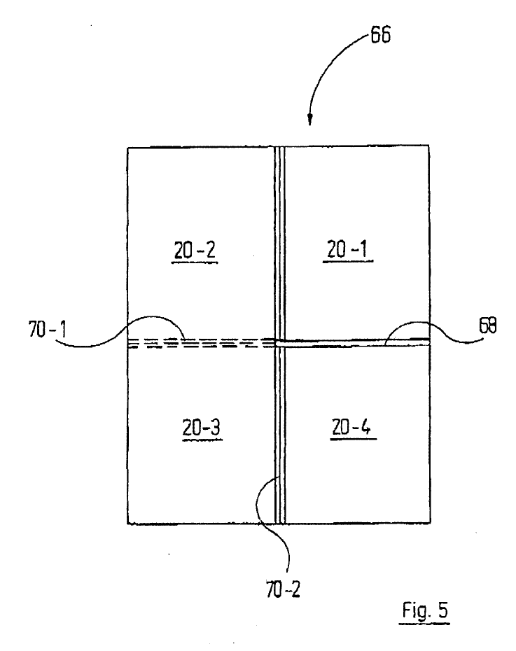

FIG. 5 shows a memory film arrangement which can be switched between a one-layer scan configuration shown in FIG. 5 and a folded, four-layer recording configuration.

A memory film sheet 66 has a horizontal slit 68, which is in the vertical middle, and extends to the horizontal middle. On the side of the memory film sheet 66 at the back in FIG. 5, and extending the slit 68, a notch 70-1 runs, and is taken almost to the front of the memory film sheet 66, so that at the base of the notch, a film hinge is formed.

Similarly, on the front of the memory film sheet 66, in the middle, a vertical notch 70-2, which continues over the whole length, and in the depth direction almost reaches the back of the memory film sheet 66, is provided. In this way, on the back of the memory film sheet 66, two vertical film hinges are obtained.

The memory film sheet 66 shown in FIG. 5 can be folded into a four-layer geometry by folding the memory film piece 20-1 against the back of the memory film piece 20-2. Similarly, the memory film piece 20-2 is folded against the back of the memory film piece 20-3. The front of the memory film piece 20-2 is now folded onto the front of the memory film piece 20-3.

In this recording configuration, the four-layer memory film sheet 66 is exposed, so that on the different memory film pieces 20-1 to 20-4, the above-mentioned single images are again obtained.

For reading the single images of the memory film pieces 20-1 to 20-4, the memory film sheet 66, now folded back again into flat, one-layer geometry, can be inserted into a scanner, which is suitable for processing correspondingly large formats. The whole memory film sheet 66 is then read in one operation, the scanner knowing, either by setting, detection of the notches 70 or detection of the similarity of the contours of the single images of the memory film pieces 20, that it is confronted with a multiple recording.

To align the single images, the alignment computer 50 first reflects the different single images, according to the folding movements between recording geometry and scan geometry, on vertical and horizontal axes, and in this way a set of single images such as would have been obtained if four memory film pieces 20, which are mechanically independent of each other, had been stacked for recording, is obtained. From this point, the single images are further processed as described in detail above, with reference to FIG. 3. However, only small, fine adjustments of the positions of the single images are necessary, since the relative positions of the memory film pieces 20-1 to 20-4 are very well determined by the film hinges.

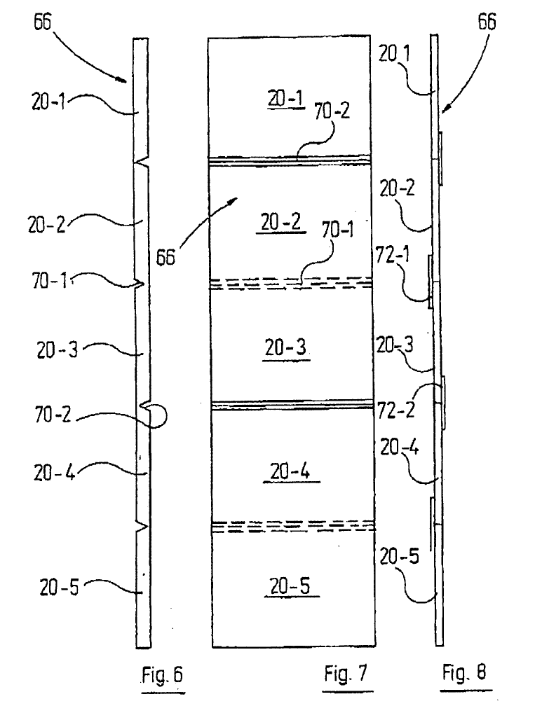

FIG. 6 too shows a memory film sheet 66, which can be moved into a multi-layer recording configuration by folding areas. Components which have already been described in functionally similar form with reference to FIG. 5 have the same reference symbols again.

It can be seen that the flat memory film sheet 66 according to FIGS. 6 and 7 can be converted into a zigzag geometry, in which there are then five memory film pieces 20-1 to 20-5 one behind the other.

FIG. 8 shows a similar memory film sheet 66, which however is produced from independent memory film pieces 20-i, using glued-on hinge film strips 72-1 and 72-2, which are glued alternately from one side or the other via the points of impact of the memory film pieces 20-1 to 20-5. The hinge film strips 72 are produced from a material which is transparent to X-ray light, so that they do not cast shadows. This can involve a thin (e.g. 1 μm to 20 μm thick) plastic film, the X-ray absorption of which is less than 5%. Also, the adhesive which is used for gluing is of organic type, and because of the small atomic numbers of the chemical elements it contains, it absorbs X-ray light only slightly.

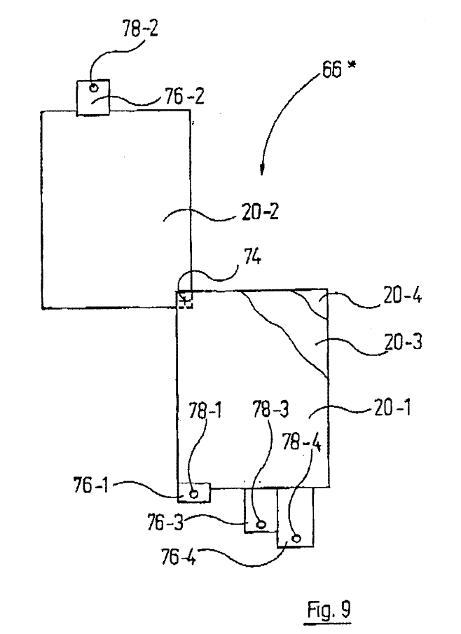

FIG. 9 shows another embodiment of a memory film arrangement 66*, which comprises multiple memory film pieces 20-1 etc. one behind the other. The memory film pieces 20 are made as independent pieces, which are held together rotatably by a bearing shaft 74, which is provided at one corner.

In FIG. 9, the memory film pieces 20-1, 20-3 and 20-4 are shown in the recording configuration one behind the other, whereas memory film piece 20-2 is shown in a scan configuration.

To move the single memory film pieces between these two working positions, each memory film piece carries at its lower edge an actuating clip 76-1 to 76-4, with a coupling hole 78-1 to 78-4, on which an adjusting tool of the scanner which is used for reading can grip, at its free end.

Using this adjusting tool, the film pieces 20-1 to 20-4 can be deliberately moved individually, limit stops (not shown) being provided to determine the recording configuration or scan configuration precisely.

Thus with the memory film arrangement 66 shown in FIG. 9 too, the memory film pieces 20-1 and 20-4 can be placed in alignment one behind the other to record an X-ray image, and the single memory film pieces can be placed individually in the scan plane of a reading device, to read the latent image.

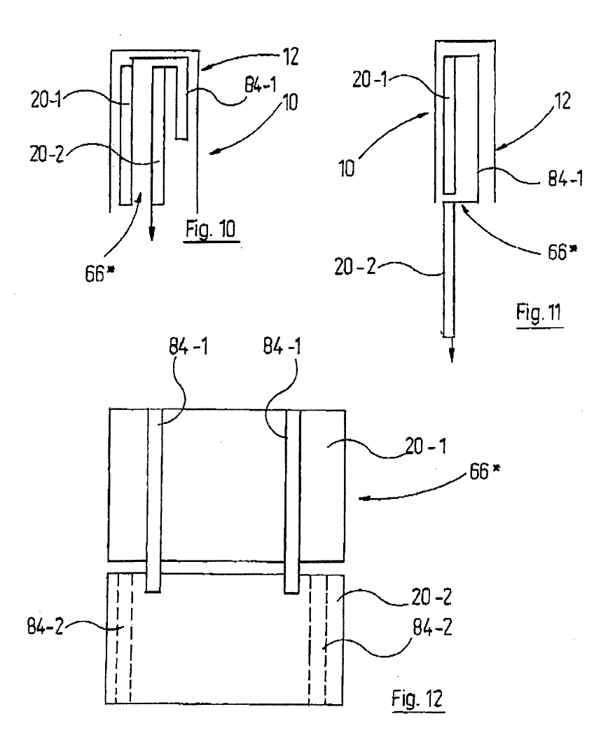

The embodiment according to FIG. 10 shows a memory unit 10 with two memory film pieces 20-1, which are one behind the other in the cassette 12. The memory film pieces 20-1 and 20-2 are now flexibly joined to each other by two tapes 84-1 at a distance from each other.

These tapes are again produced from a plastic material which does not absorb X-ray light. When the memory film piece 20-1 is pulled out of the cassette 12, after a certain distance, which is determined by the length of the tapes 84-1, the memory film piece 20-1 is also pulled out of the cassette. The two memory film pieces 20-1 and 20-2 thus reach a coplanar arrangement, as shown in FIG. 12. In this geometry, they can then be read together in a scanner.

In FIG. 12, it is additionally indicated that the number of memory film pieces 20 which are joined to each other can be further enlarged by fixing a third memory film piece by tapes 84-2 to the memory film piece 20-2, in the same way as described above.

However, the tapes 84-2 are displaced in the outward direction compared with the tapes 84-1, so that the tapes 84-1 and 84-2 do not interfere with each other. If a further, fourth memory film piece is appended, tapes 84 which are arranged similarly to the tapes 84-1 would be used.

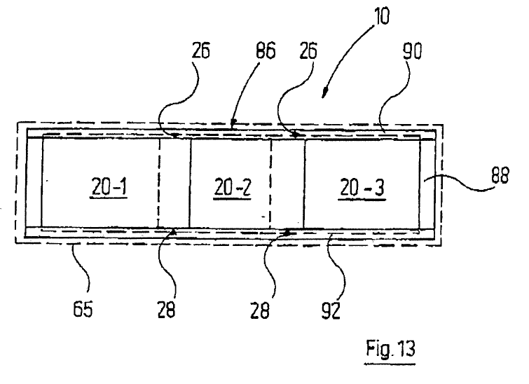

In the case of the embodiment according to FIG. 13, a narrow, elongated film holder 86, which has low rails 90, 92 projecting from a rear wall 88, is provided.

Memory film pieces 20-1, 20-2 and 20-3 are pushed into the rails 90, 92, in such a way that the end sections on the left of the memory film pieces in FIG. 13 extend under the end sections on the right of the adjacent memory film piece on the left. Thus altogether, a scale-like arrangement of the memory film pieces 20-1, 20-2 and 20-3 is obtained.

Thus altogether, using memory film pieces which have a normal width-height ratio of sheet material (about 1.4 to 1), a memory film piece arrangement of which the length is much greater than its height can be produced. Thus using smaller memory film pieces such as are used for intra-oral recordings, for instance, an extended memory film piece arrangement which is suitable for panoramic recordings can be obtained.

In the case of the embodiment according to FIG. 13, the overlapping image areas are again used to align the images of the different memory film pieces.

The panoramic recording can now be put together from the individual partial images, by using, from the single images, only those areas which were freely exposed to the X-ray light, but not those image areas which were behind an adjacent memory film piece. These image areas are used only to align the individual partial images, but not to generate a total image.

To make it possible to align the single images even in the case of low-contrast recordings, the film holder 86, in each overlapping area of the memory film pieces, has a pair of marks 26-1, 28-1 or 26-2, 28-2, which are again made of material which is not transparent to X-ray light. Their geometries are different, so that the correct sequence of memory film pieces can be reconstructed from the shape of the marks if it is lost.

The film holder 86, together with the memory film pieces 20-1, 20-2 and 20-3 which are pushed onto it, is inside a wrapping 65, which is not transparent to light.

It is understood that in a modification, longer or shorter linear memory film piece arrangements, which partly overlap like scales in the way described above, can be provided. The scale-like overlapping is also possible in two dimensions (so in FIG. 13, also in the vertical direction), so that a large memory film piece arrangement can be produced from smaller memory film pieces, if such a thing is not available in one-piece form at the time.

In general, when materials are reused, care will be taken that surfaces which lie on each other are smooth and ensure low friction, so that the surfaces of the memory film pieces, which are sensitive to scratching, are not damaged.

In the case of the embodiment described above, where the memory film pieces were coupled by flexible tapes, profile rails can be additionally provided on the longitudinal edges running perpendicularly to the drawing plane. When the memory film pieces are pulled out, these profile rails interlock with each other, so that the memory film pieces are guided together.

As explained above, with the invention an improvement of the product of resolution and sensitivity is obtained. This means that for a given resolution, it is possible to work with a significantly lower radiation dose, which is desirable with respect to the radiation load on the patient. With a given radiation dose, structures can still be detected even in optically denser sections of the object.

It is again emphasized that the above-described embodiments of the present invention, particularly, any “preferred” embodiments, are possible examples of implementations merely set forth for a clear understanding of the principles of the invention. Many variations and modifications may be made to the above-described embodiments of the invention without substantially departing from the spirit and principles of the invention. All such modifications are intended to be included herein within the spirit of the invention and the scope of protection is only limited by the accompanying claims.

1. A memory unit for producing radiographic images of living or dead material using electromagnetic or corpuscular radiation, said memory unit including memory film material, which contains memory centres of a memory luminous material, which can be brought by the radiation into a metastable excited state, from which they relax by emitting fluorescent light if they are irradiated by reading light, wherein the memory film material can be moved between a recording configuration, in which multiple memory film sections are one behind the other, and a scan configuration, in which the memory film sections are each individually accessible for the reading light.

2. The memory unit of claim 1, wherein a holding device, which in the recording configuration holds single memory film pieces together, in full alignment or partly overlapping alignment.

3. The memory unit of claim 2, wherein the holding device is in the form of a lightproof cassette.

4. The memory unit of claim 3, wherein the lightproof cassette has at least one movable wall.

5. The memory unit of claim 4, wherein the movable wall is in the form of a housing part, a lid, a bolt, or a pivotable flap.

6. The memory unit of claim 5, wherein the cassette has two movable walls opposite each other.

7. The memory unit of claim 3, further comprising at least a front cassette wall having plane-parallel main limiting surfaces.

8. The memory unit of claim 1, wherein the holding device is made of material which is transparent to X-ray light.

9. The memory unit of claim 1, wherein between at least two memory film sections, at least one absorber layer, which is partly transparent to X-ray light, is provided.

10. The memory unit of claim 9, wherein the memory film section stack contains at least two absorber layers which are partly transparent to the radiation, and which have different absorption curves.

11. The memory unit of claim 1, wherein on the back of the stack of memory film sections, a final absorber layer, which absorbs the radiation strongly, is provided.

12. The memory unit of claim 11, wherein the final absorber layer is joined to the holding device.

13. The memory unit of claim 1, wherein on the front of the arrangement of memory film sections, at least one reference marking means which absorbs the radiation is provided.

14. The memory unit of claim 13, wherein the at least one reference marking means is carried by the holding device.

15. The memory unit of claim 1, wherein the memory film sections are joined captively to each other.

16. The memory unit of claim 15, wherein at least some of the memory film sections are joined by hinges.

17. The memory unit of claim 15, wherein at least some of the memory film sections are joined by flexible joining means.

18. The memory unit of claim 17, wherein the flexible joining means belonging to adjacent memory film sections are offset relative to each other.

19. The memory unit of claim 15, wherein at least some of the memory film sections are rotatably joined to each other by a bearing shaft.

20. The memory unit of claim 1, wherein among the memory film sections, there are at least two which differ regarding the absorption of radiation by their memory luminous material.

21. The memory unit of claim 1, wherein among the memory film sections, there are at least two which differ in their thickness.

22. The memory unit of claim 1, wherein among the memory film sections, there are at least two which differ in the proportion by weight of memory luminous material.

23. The memory unit of claim 1, wherein among the memory film sections, there are at least two which differ in the atomic numbers of the components of their memory luminous materials.

24. The memory unit of claim 1, wherein among the memory film sections, there are at least two which differ in the absorption of reading light by a matrix material, in which the memory luminous material is distributed.

25. A method of reading the memory unit of claim 1, the method comprising the steps of:
a) converting the memory unit from a multilayer recording configuration to a one-layer scan configuration;
b) reading the different memory film sections separately, and storing the corresponding single image pixel signals separately; and,
c) combining the single image pixel signals into total image pixel signals.

26. The method of claim 25, wherein the single images are aligned before being combined, by a correlation method and/or using exposed marks with rotation and/or shifting and/or by changing the imaging scale.

27. The method of claim 25, wherein the single image pixel signals are added to the total image pixel signals using weighting factors.

28. The method of claim 27, wherein the weighting factors are determined depending on the intensities of at least two single images.

29. The method of claim 25, wherein the total image pixel signals are subjected to an amplitude transformation according to a specified characteristic curve or according to a root function.

30. The method of claim 25, wherein the single image pixel signals are combined into the total image pixel signals by adding their amplitudes, weighted as required.

31. The method of claim 25, wherein the single image pixel signals are combined into the total image pixel signals while selecting a subset of the single image pixel signals which are within a specified amplitude window, and that the selected single image pixel signals are weighted according to the proportion of X-ray light which the associated memory film section absorbs.
